(19) United States
(12) Patent Application Publication
(10) Pub. No.: US 2012/0024549 A1
(43) Pub. Date: Feb. 2, 2012

(54) FIRE EXTINGUISHING DEVICE

(75) Inventors: Yuan-Huan CHANG, Yuanlin Jen (TW); Ming-Hua CHANG, Yuanlin Jen (TW)

(73) Assignee: YUE SAN ENTERPRISE CO., LTD., Changhua Hsien (TW)

(21) Appl. No.: 12/960,275

(22) Filed: Dec. 3, 2010

(30) Foreign Application Priority Data
Jul. 27, 2010 (TW) 099214336
Nov. 9, 2010 (TW) 099221727

(51) Int. Cl. A62C 27/00

(52) U.S. Cl. 169/52

(57) ABSTRACT

A fire extinguishing device is disclosed. The fire extinguishing device is installed at a motor vehicle with an engine. The fire extinguishing device includes a first and a second water tanks, a foam tank and a spray gun. Utilizing a pump and a driving unit, the fire extinguishing device in the present invention uses the engine in the motor vehicle without installing and purchasing another engine to become a flexible fire extinguisher which can as well save costs.

### FIELD OF THE INVENTION

This invention generally relates to a fire extinguishing device. More specifically, this invention relates to the fire extinguishing device using an engine in a motor vehicle to flexibly extinguish the fire without purchasing or installing new equipment.

### BACKGROUND OF THE INVENTION

Conventionally, a fire truck may not be able to approach a fire scene because of some situational problems. For example, when the fire truck comes to the fire scene, it may not be able to effectively extinguish the fire because the fire truck may be too large for a small street or some vehicles block the street so the fire truck cannot be closer to the fire scene. Moreover, the length of a hose in the fire truck is limited and it may be even harder to extinguish when the fire truck cannot get closer to the fire scene due to situational problems. Therefore, a light and flexible fire extinguishing device to replace conventional fire truck is needed to reduce the damage caused by the fire.

Although a conventional “light and flexible” fire truck can achieve the goal mentioned above, it needs dual power to drive. So, the conventional “light and flexible” fire truck cannot smoothly be turned on or an engine of a water pump cannot be turned on if the engine of the fire truck is not well-maintained. If the fire truck can be driven by a single power, it can be powered by the water pump to immediately take action to put out the fire when it is at the fire scene. This can not only solve the problem of starting the engine, but also obtain much more time for rescue.

### SUMMARY OF THE INVENTION

The present invention merely utilizes the engine in the motor vehicle without installing or purchasing another engine to become a fire extinguishing device with excellent flexibility which can as well save the cost.

To achieve the goal mentioned above, a fire extinguishing device is set up at a motor vehicle with an engine, the fire extinguishing device including:

a first water tank, which is located at a rear end of the motor vehicle and equipped with a first injecting hole; a first meter and a first outlet tube located at one side of the first water tank;

a second water tank, which is located at a front end of the motor vehicle and equipped with a second injecting hole; a second meter and a second outlet tube located at one side of the second water tank;

a foam tank, which is located at one side of the first water tank and equipped with a third injecting hole; a third meter and a third outlet tube located at one side of the foam tank;

a spray gun, which is located at one side of the first water tank that has a base to secure the spray gun; the spray gun connecting to one end of a connection tube which is located at a upper portion of the first water tank, and the spray gun having a switch;

a pump located at a read end of the motor vehicle, having a accelerating unit, a pump switch, a forth outlet tube, wherein the pump switch connects with the first outlet tube, the second outlet tube and the third outlet tube, and the fourth outlet tube connects to the other end of the connection tube;

a driving unit power by the engine, having a driving switch, a clutch, a connecting assembly, wherein the driving switch is located at a driver's seat of the motor vehicle, the clutch is set up at an axis of rear tires, and the connecting assembly is adapted to transmit motions between the pump and the clutch;

a hose hung at a front end of the motor vehicle;

a lighting unit located at an upper end of the motor vehicle, having a plurality of illuminating lights and an alarm.

### BRIEF DESCRIPTION OF THE DRAWINGS

FIG. 1 illustrates a three-dimensional assembled view of the present invention.

### DETAIL DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

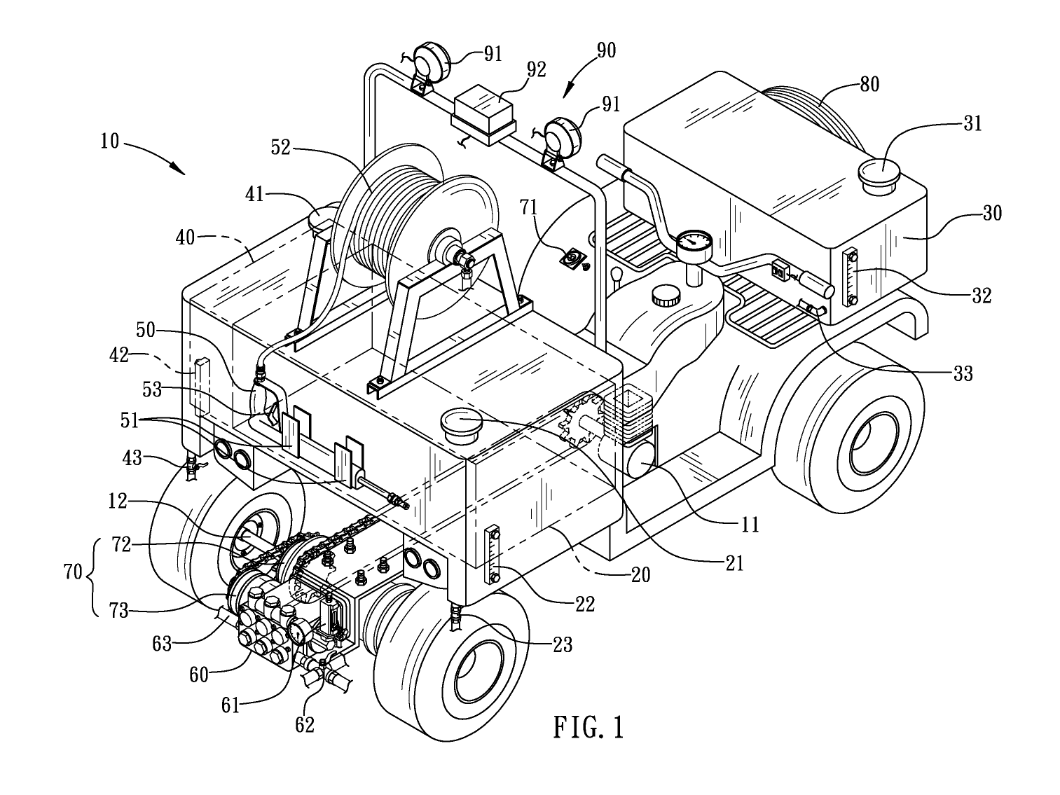

Referring to FIG. 1, a fire extinguishing device is set up on a motor vehicle (10) with an engine (11), the fire extinguishing device including:

a first water tank (20), which is located at a rear end of the motor vehicle (10) and equipped with a first injecting hole (21) to provide water from water source through the first injecting hole (21); a first meter (22) set up at a side of the first water tank (20) to monitor the amount of water therein; and a first outlet tube (23) located at one side of the first water tank (20);

a second water tank (30), which is located at a front end of the motor vehicle (10) and equipped with a second injecting hole (31) to provide water from water source through the second injecting hole (31); a second meter (32) set up at one side of the second water tank (30) to monitor the amount of water therein; and a second outlet tube (33);

a foam tank (40), which is located at one side of the first water tank (20) and equipped with a third injecting hole (41) to provide foam therethrough; a third meter (42) set up at a side of the foam tank (40) to monitor the amount of foam therein; and a third outlet tube (43);

a spray gun (50), which is located at one side of the first water tank (20) that has a base (51) to secure the spray gun (50); the spray gun (50) connecting to one side of a connection tube (52) which is located at a upper portion of the first water tank (20), and the spray gun (50) having a switch (53) to open or close the spray gun (53) as to whether spraying water or foam;

a pump (60) located at a read end of the motor vehicle (10), having a accelerating unit (61), a pump switch (62), a forth outlet tube (63), wherein the accelerating unit (61) adds more pressure to the pump (60) which causes the pump switch (62) to connect with the first outlet tube (23), the second outlet tube (33) and the third outlet tube (43), such that the pressure can be applied to any outlet tube to the pump (60); and the fourth outlet tube (63) connects to the other end of the connection tube (52);

a driving unit (70) power by the engine (11), having a driving switch (71), a clutch (72), a connecting assembly (73), wherein the driving switch (71) is located at a driver's seat of the motor vehicle (10) to start the pump (60) and the clutch (72) simultaneously, the clutch (72) is set up at an axis (12) of rear tires, and the connecting assembly (73) is adapted to transmit motions between the pump (60) and the clutch (72), but does not transmit motions to the axis (12) of rear tires;

a hose (80) hung at a front end of the motor vehicle (10), which is adapted to connect an outside water source (e.g. faucet, hydrant) to reload the first water tank (20) and the second water tank (30) when water is insufficient in the first (20) and second (30) water tanks; and

a lighting unit (90) located at an upper end of the motor vehicle (10), having a plurality of illuminating lights (91) and an alarm (92); the illuminating light (91) providing illumination functions to the motor vehicles (10) at night or in some dark areas, and the alarm (92) providing an audible alarm.

The structure, position and interconnection relationship are described above. Next, an anticipated effect of combination of each abovementioned element is described as following:

When fire occurs in small streets, large fire trucks are not easy to get in to put out the fire. In the present invention, the motor vehicle (10) can easily go through small streets to reach the fire scene. Also, the motor vehicle (10) is not turned off to keep the engine (11) in operation which simultaneously starts the driving switch (71). Moreover, the engine (11) drives the pump (60) through the connecting assembly (73) by utilizing the clutch (72), which does not transmit motion to the axis (12) of the rear tires. The accelerating unit (61) adds more pressure to the pump to drive the water or foam.

The pump switch (62) can be switched to connect either the first outlet tube (23), the second outlet tube (33), or the third outlet tube (43) to pump the water in the first water tank (20) or the second water tank (30), or the foam in the foam tank (40) to the spray gun (50) through the fourth outlet tube (63) and the connection tube (52). The spray gun (50) is then targeting an origin of the fire and turned on to spray either water or foam to extinguish the fire and avoid extensive fire damages.

If the water in the first water tank is running out but the fire is not yet put out, the pump switch (62) is activated to use the water in the second water tank (30). Meanwhile, the hose (80) can connect to outside water sources such as faucets, hydrants, to reload the water to the first water tank (20).

The present invention merely utilizes the engine in the motor vehicle without installing or purchasing another engine to become a fire extinguishing device with excellent flexibility which can as well save the cost.

Having described the invention by the description and illustrations above, it should be understood that these are exemplary of the invention and are not to be considered as limiting. Accordingly, the invention is not to be considered as limited by the foregoing description, but includes any equivalents.

### KEY ELEMENTS

(10) Motor vehicle
(11) Engine
(12) Axis of rear tires
(20) First water tank
(21) First injecting hole
(30) Second water tank
(31) Second injecting hole
(40) Third water tank
(41) Third injecting hole
(50) Spray gun
(51) Base
(60) Pump
(61) Accelerating unit
(62) Pump switch
(63) Fourth outlet tube
(70) Driving unit
(71) Driving switch
(72) Clutch
(73) Connecting assembly
(80) Hose
(90) Lighting unit
(91) Illuminating light
(92) Alarm

1. A fire extinguishing device installed at a motor vehicle with an engine, the fire extinguishing device including:
a first water tank, which is located at a rear end of the motor vehicle and equipped with a first injecting hole; and a first outlet tube located at one side of the first water tank;
a foam tank, which is located at one side of the first water tank and equipped with a third injecting hole; and a third outlet tube located at one side of the foam tank;
a spray gun, which is located at one side of the first water tank that has a base to secure the spray gun; the spray gun connecting to one end of a connection tube which is located at a upper portion of the first water tank, and the spray gun having a switch;
a pump located at the motor vehicle, having a accelerating unit, a pump switch, a forth outlet tube, wherein the pump switch connects with the first outlet tube and the third outlet tube, and the fourth outlet tube connects to the other end of the connection tube;
a driving unit power by the engine, having a driving switch, a clutch, a connecting assembly, wherein the driving switch is located at a driver's seat of the motor vehicle, the clutch is set up at the motor vehicle, and the connecting assembly is adapted to transmit motions between the pump and the clutch.

2. The fire extinguishing device of claim 1, further comprising a second water tank, which is located at a front end of the motor vehicle and equipped with a second injecting hole; a second outlet tube located at one side of the second water tank and connected with a switch; and the clutch located at an axis of rear tires.

3. The fire extinguishing device of claim 1, wherein a first meter, a second meter and a third meter are located at the first water tank, the second water tank and the third water tank, respectively.

4. The fire extinguishing device of claim 1, further comprising a hose hung at a front end of the motor vehicle.

5. The fire extinguishing device of claim 1, further comprising an illuminating unit which is located at an upper portion of the motor vehicle, having a plurality of illuminating lights and an alarm.

6. The fire extinguishing device of claim 2, wherein a first meter, a second meter and a third meter are located at the first water tank, the second water tank and the third water tank, respectively.
